(19) United States
(12) Patent Application Publication
(10) Pub. No.: US 2007/0001812 A1
(43) Pub. Date: Jan. 4, 2007

(54) Systems and methods for optimizing communications between an RFID reader and a tag population using partial binary tree traversal

(75) Inventor: Kevin J. Powell, Annapolis, MD (US)

Correspondence Address: STERNE, KESSLER, GOLDSTEIN & FOX PLLC, 1100 NEW YORK AVENUE, N.W., WASHINGTON, DC, 20005, US

(73) Assignee: Symbol Technologies, Inc., Holtsville, NY (US)

(21) Appl. No.: 11/169,567

(22) Filed: Jun. 30, 2005

(51) Int. Cl. H04Q 5/22

(52) U.S. Cl. 340/10.2; 375/240

(57) ABSTRACT

System and methods for optimizing communications between an RFID reader and a population of tags are described. To increase a read rate, the reader and tags use a partial binary tree traversal. In partial binary tree traversal, a first portion of a tag identification sequence is read. A set marker command is then transmitted to a group of tags causing the tags to set a bit position for start of subsequent binary tree traversal. The subsequent binary tree traversal for the tag group starts at the marked position. Thus, the reader and group of tags negotiate a subset of the identification sequence instead of the entire identification sequence.

### FIELD OF THE INVENTION

The present invention is related to systems and methods for communicating between radio frequency identification (RFID) tags and an RFID reader.

### BACKGROUND OF THE INVENTION

In an RFID system, an RFID reader may be required to communicate with a large number of different RFID tags within a given communication range. Where each of the different RFID tags is identified by a unique identification number, it is imperative that the RFID reader be able to quickly and accurately read the identification number associated with each tag.

One major application of RFID systems is electronic inventory. In modem business, maintaining an accurate inventory of merchandise is crucial. In the past, taking inventory was an entirely manual process, and therefore slow and expensive. In an RFID electronic inventory system, an RFID tag is attached to each item to be inventoried. Each RFID tag is assigned a unique tag identification number.

In typical inventory applications, a large number of tagged items are stacked on a pallet. For example, a single pallet may have 50 boxes containing Product X and 50 boxes containing Product Y. The tags associated with Product X will have similar tag identification sequences and the tags associated with Product Y will have similar tag identification sequences. For example, Product X tag identification sequences will cluster at one section of a binary tree and Product Y tag identification sequences will cluster at a different section of the binary tree.

Consequently, a need exists for a technique that permits an RFID reader to efficiently read a population of RFID tags in a manner that optimally utilizes information about the tag population gained by the RFID reader, other RFID readers, or other systems compiling information for RFID readers, during or before the reading process.

A further need exists for a method of communicating between an RFID reader and a population of RFID tags that maximizes the read rate of a population of RFID tags.

### BRIEF SUMMARY OF THE INVENTION

The present invention is directed to a system and method for optimizing communication between an RFID reader and a population of RFID tags. In accordance with aspects of the invention, the RFID system includes one or more readers and a plurality of tags.

The present invention is directed to a system and method for performing partial binary tree traversals. In accordance with an aspect of the invention, a reader reads a first portion of a tag identification bit sequence using a tag interrogation protocol. In an aspect, the tag identification protocol is a binary tree traversal protocol. The reader then causes a first group of tags in the tag population to transition to a command state. While the first group of tags is in the command state, the reader transmits a command that causes the first group of tags to set a marker at a specific bit position. In a further aspect of the invention, the reader transmits the bit position value to the first group of tags following the set marker command. The reader then reads a second portion of the tag identification bit sequence for a first tag in the first group of tags starting from the marked bit position. The reader repeats the reading step for each tag in the first group of tags.

In accordance with a further aspect of the present invention, an RFID tag engages in negotiation of a first portion of its tag identification sequence with a reader. Upon receipt of a first sequence of symbols, the tag transitions to a command state. The tag then receives a set marker command from the reader which causes the tag to set a bit position for the start of a subsequent negotiation for the second portion of its tag identification sequence. The tag then engages in negotiation of the second portion of its identification sequence starting from the marked bit position.

These and other advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where one or more RFID tag readers communicate with an exemplary population of RFID tags, according to the present invention.

FIG. 2 is a block diagram of a tag, according to an example embodiment of the present invention.

FIG. 3 illustrates various operating states in a state diagram for tag, according to an embodiment of the present invention.

FIG. 4 is a flowchart illustrating an example operation of a reader directed partial binary tree traversal from the perspective of a single tag, according to an embodiment of the present invention.

FIG. 5 is a flowchart illustrating an example operation of the reader directed partial binary tree traversal from the perspective of the reader, according to an embodiment of the present invention.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

1. Overview

1.1 Tag Interrogation Environment

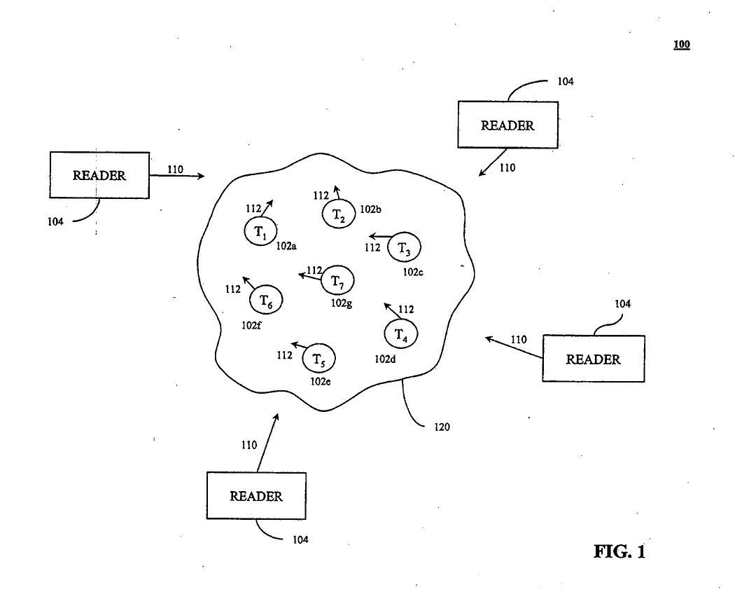

Before describing the present invention in detail, it is helpful to describe an example environment in which the invention may be implemented. The present invention is particularly useful for improving the efficiency of interrogations in radio frequency identification (RFID) applications. FIG. 1 illustrates an environment 100 where one or more RFID tag readers 104 communicate with an exemplary population of RFID tags 120, according to the present invention. As shown in FIG. 1, the population of tags 120 includes seven tags 102a-102g. According to embodiments of the present invention, a population of tags 120 may include any number of tags 102. In some embodiments, a very large numbers of tags 102 may be included in a population of tags 120, including hundreds, thousands, or even more.

Exemplary environment 100 also includes one or more readers 104. These readers 104 may operate independently or may be coupled together to form a reader network. A reader 104 may be requested by an external application to address the population of tags 120. Alternatively, the reader may have internal logic that initiates communication. When the reader is not communicating with the population of tags, the reader 104 typically does not emit RF energy. This allows other readers to act upon the same population of tags, but from a different orientation, so as to achieve as complete of coverage with RF signals into the entire population of tags as possible. In addition, the same reader may act upon the same population of tags using a different frequency to increase tag coverage.

According to the present invention, signals 110 and 112 are exchanged between a reader 104 and the tags 102 according to one or more interrogation protocols. An exemplary interrogation protocol is, the binary tree traversal protocol described below. Signals 110 and 112 are wireless signals, such as radio frequency (RF) transmissions. Upon receiving a signal 110, a tag 102 may produce a responding signal 112 by alternatively reflecting and absorbing portions of signal 110 according to a time-based pattern or frequency. This technique for alternatively absorbing and reflecting signal 110 is referred to herein as backscatter modulation. The present invention is also applicable to RFID tags that communicate in other ways.

1.2 Tag Embodiments

1.2.1 Structural Overview

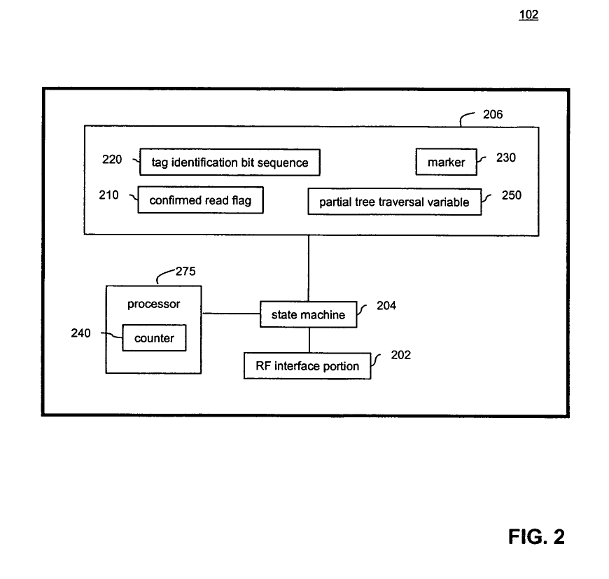

FIG. 2 is a block diagram of a tag 102, according to an example embodiment of the present invention. Tag 102 includes an RF interface portion 202, a state machine 204, a processor 275, and a data storage section 206. Data storage section 206 may include one or more memory elements as required by a particular application. Processor 275 includes a null counter 240. Data storage section 206 stores information used by tag 102 during communication with reader 104. In an embodiment, information stored in data storage module 206 includes a confirmed read flag, a tag identification number 220, an optional marker 230, and an optional null counter match variable 250.

Tag 102 is identified by a tag identification bit sequence. The tag identification bit sequence may be permanently stored or may be temporarily stored in memory in data storage section 206. In an embodiment, tag identification bit sequences are hierarchical. That is, for a tag population, a subset of the tag identification bit sequence is identical for all tags in a tag population. Thus, in such an embodiment, for a tag population 120, reader 104 does not need to negotiate the entire identification bit sequence to identify each tag in the tag population. For example, a tag identification sequence may consist of a manufacturer bit string, a lot number bit string, and tag ID bit string. In this example, all tags in a tag population 120 may have the same manufacturer bit string and a subset of all tags in tag population 120 will have the same lot number bit string. The tag ID bit string is then unique for each tag in the tag population.

The confirmed read flag 210 indicates whether tag 102 has been successfully read during a binary tree traversal. Flag 210 is stored in a memory in data storage section 206. In an embodiment, the confirmed read flag 210 retains its value for a period of time regardless of whether tag 102 experiences a power loss.

When present, marker 230 indicates the bit position to be used as the first bit position during a binary tree traversal. In an embodiment, marker 230 is stored when tag 102 receives a set marker command from a reader during a partial binary tree traversal. In an alternate embodiment, tag 102 always stores marker 230. During a full binary tree traversal, marker 230 is set to the first bit position in the tag identification bit sequence.

When present, null count match variable 250 indicates a number of designated symbols, such as the number of NULL symbols, that must be received from a reader in order for tag 102 to perform partial binary tree traversal. In an embodiment, the value of null counter match variable 250 is set via a command from reader 104. In this embodiment, reader 104 can flexibly determine the value to be used to initiate partial tree traversal of matched tags. In an alternate embodiment, the value of null counter match variable 250 is set to a specific value.

Processor 275 includes a counter 240. In an embodiment, counter 240 is cleared when a NULL symbol is received from reader 104 causing tag 102 to transition from traversal mute state 314 to tree start state 310. Counter 240 is then incremented each time a NULL symbol is received from reader 104 when tag 102 is in tree start state until counter 240 equals the value of null counter match variable 250. As would be appreciated by a person of skill in the art, counter 240 could be implemented such that counter 240 is set to the value of null counter match variable 250 when tag 102 is in a tree traversal state. Counter 240 is then decremented each time a NULL symbol is received from reader 104 when tag 102 is in tree start state until counter 240 equals zero. Additional alternative implementations for processor 275/counter 240 would be known to a person of ordinary skill in the art.

Note that the use of the terminology “counter” is not intended to imply a specific implementation. Each counter can be implemented as a register or in another manner including hardware, software, firmware, or any combination thereof.

RF interface portion 202, together with tag antenna(s) (not shown), provide a bi-directional communications interface with reader 104. The RF interface receives RF signals from reader 104 and demodulates the signals into digital information symbols. The RF interface also modulates digital information symbols into RF signals.

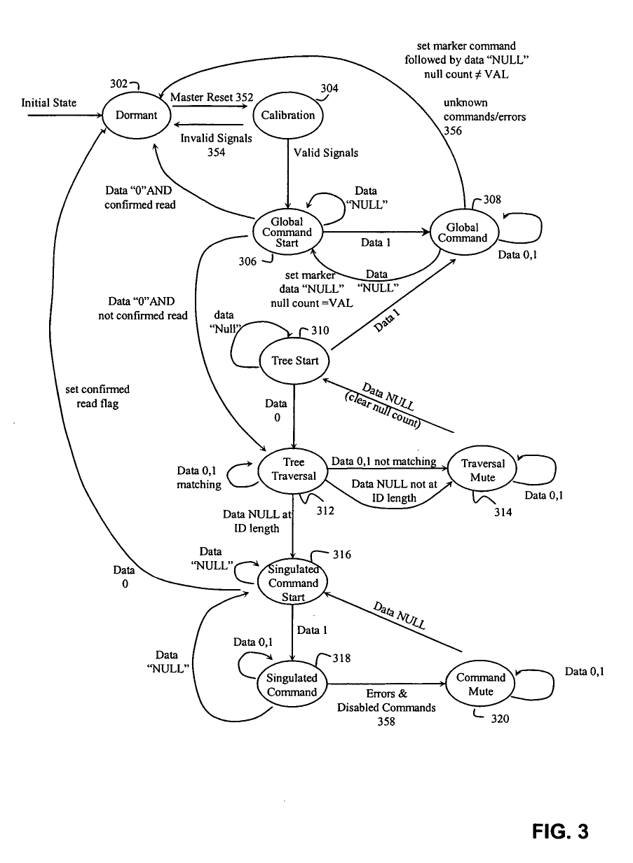

State machine 204 may include logic, a processor (including processor 275), and/or other components that control the operation of tag 102. State machine 204 receives demodulated information symbols from RF interface portion 202. State machine 204 also accesses information in data storage section 206 as needed. In an embodiment, state machine 204 is implemented with digital circuitry, such as logic gates. Further details regarding state machine 204 are provided below with reference to FIG. 3.

1.2.2 Operational States of a Tag

Tag 102 can exist in various operating states. Each of these operating states describes a mode of operation for tag 102. Upon the occurrence of certain events, tag 102 can transition from one operating state to another. For example, upon occurrence of an event, tag 102 can transition from a present operating state, which is the state that tag 102 is operating in when the event occurs, to a new operating state, as dictated by the combination of the present operating state and the event.

Events can be triggered by detection of edges in the transmission from reader 104, by passage of a defined period of time, by occurrence of one or more conditions, or by a combination of edge detection, time passage, and/or occurrence of one or more conditions. Examples of events include master reset event, master dormant event, and a data “NULL.”

FIG. 3 illustrates various operating states in a state diagram for tag 102, according to an embodiment of the present invention. In FIG. 3, each operating state is shown as an oval, and transitions between operating states are shown as connections between the ovals. The transitions are annotated with text that describes a corresponding event.

The paragraphs below describe the operating states and the respective transitions shown in FIG. 3. These particular states and transitions are presented by way of example only. Additional and alternative operating states, transitions, and transition causing events can be employed without departing from the spirit and scope of the present invention.

The first state is dormant state 302. During dormant state 302, tag 102 is largely inactive. Therefore, power is conserved while tag 102 is in dormant state. Tag 102 enters dormant state upon powering up, after receipt of a master dormant event, and at other times described below.

As shown in FIG. 3, tag 102 transitions from dormant state 302 to calibration state 304 upon a master reset event 352. In an embodiment, tag 102 can only transition to calibration state 304 from dormant state 302. In addition, only a master reset event 352 will result in a transition from dormant state 302. In alternate embodiments, other events may cause transitions to calibration state 304.

In calibration state 304, tag 102 initializes its timing circuitry. In an embodiment, in calibration state 304, tag 102 will not generate logical symbols “0,” or “1” as they have not yet been defined. Instead, in calibration state 304, tag 102 performs an oscillator calibration procedure and a data calibration procedure. The oscillator calibration procedure involves tag 102 receiving multiple oscillator calibration pulses from reader 104, defined herein as edge transition (data) events. Specific timing is provided between edge transition events. Similarly, the data calibration procedure involves tag 102 receiving multiple data calibration pulses from reader 104. Data calibration results in the definition of data symbols used in communication between the reader and the tag.

As shown in FIG. 3, tag 102 may transition from calibration state 304 to dormant state 302 upon the occurrence of an event 354. In an embodiment, event 354 is defined by the reception of a signal that is not representative of timing signals expected by tag 102. For example, in an embodiment, oscillator calibration signals are defined as 8 pulses of equal length. If the oscillator calibration pulses received by tag 102 are significantly unequal or not within an expected range of lengths, the pulses may be considered invalid, causing occurrence of an event 354. Hence, when tag 102 receives signals that do not cause successful oscillator calibration or data calibration procedures, event 354 occurs.

After successful completion of the calibration procedures, tag 102 transitions to global command start state 306. During global command start state 306, if a data “1” is received from reader 104, tag 102 enters global command state 308. Receipt of a data “0” when in global command start state 306 directs tag 102 to evaluate its confirmed read flag 210. The confirmed read flag 210 indicates whether the tag has previously been read. If the confirmed read flag 210 has been set (i.e., indicating that the tag has already been read), tag 102 transitions to dormant state 302. If the confirmed read flag is not set, tag 102 transitions to tree traversal state 312. In an embodiment, receipt of a data “NULL” does not effect the state of tag 102 in global command start state 306.

When operating in global command state 308, tag 102 receives a command from reader 104. Note that during global command start state 306 and global command state 308, one or more tags 102 may be active. Thus, reader 104 can place tags 102 in global command state in order to address a command to a group of tags 102 (e.g., a subset of all tags in field or all tags in the field). The command consists of multiple bits. In an embodiment, the command is 8 bits in length. As would be appreciated by persons of ordinary skill in the art, longer or shorter commands can be used with the present invention.

In an embodiment, tag 102 supports a set of mandatory global commands and one or more optional global commands. Example mandatory global commands include commands to reset the confirmed read flag 210, to set backscatter parameters, to immediately enter dormant state, and to immediately enter mute state.

In an embodiment, tag 102 supports an optional set marker command. This command sets the bit position which will be used as the first bit position during subsequent binary tree traversal. Tag 102 sets marker 230 at the bit position immediately following the bit position of the last bit of the identification number transmitted to reader 104 during a partial binary tree traversal. In an alternate embodiment, this command has a bit argument. Reader 104 provides the bit position for marker 230 in the argument. In an embodiment, the set marker command includes criteria or data specifying conditions for transitioning to a different state. For example, the set marker command may indicate that a tag should transition to dormant state if its counter value does not equal null counter match variable 250 and that the tag should transition to global command start state if its counter value equals null counter match variable 250.

Receipt of a data “NULL” while in global command state 308 indicates end of command receipt and causes tags to transition to global command start state 306 or dormant state 302. Upon receipt of the “NULL,” tag 102 compares its null counter match variable 250 to the value of null counter 240. Tag 102 transitions from global command state 308 to dormant state 302 if the tag's counter value does not equal null counter match variable 250. In this way, reader 104 can remove a group of tags 102 from a subsequent binary tree traversal. Tag 102 may also transition to dormant state upon occurrence of event 356. For example, event 356 can be the detection of communications errors within a received command or receipt of a command for an unknown or disabled function. Tag 102 transitions from global command state 308 to global command start state 306 if the tag's counter value equals null counter match variable 250.

When operating in tree traversal state 312, tag 102 transmits all or a portion of its identification bit string (e.g., identification number) to reader 104 according to a binary tree traversal protocol that enables reader 104 to quickly interrogate a population of tags 120. An example of a binary tree traversal protocol is described below.

Upon entering tree traversal state 312, tag 102 transmits a first designated bit to reader 104. For example, if tag 102 has not received a set marker command (i.e., marker 230 is not set or is set at first bit position), the first designated bit is the bit in the first bit position of the identification bit string. If tag 102 has received a set marker command, the first designated bit is the bit in the bit position indicated by marker 230. While in tree traversal state, tag 102 receives a bit from the reader. Receipt of a data “0” or data “1” causes the tag to evaluate its last transmitted identification bit. If the last transmitted identification bit matches the bit received, tag 102 remains in tree traversal state 312. If the last transmitted identification bit does not match the bit received, tag 102 transitions to traversal mute state 314. Tags transition to traversal mute state 314 in this manner as a result of an unsuccessful negotiation. For ease of description, these tags are referred to as “unmatched tags.”

Tag 102 transitions to traversal mute state 314 from tree traversal state 312 upon receipt of a data “NULL” prior to successful negotiation of all bits in the identification bit string or in the portion of the identification bit string being read. This transition results in a partial binary tree traversal. Tags transitioning to traversal mute state 314 in this manner have had one or more bits in their identification bit sequence successfully read. For ease of description, these tags are referred to as “matched tags.” Tag 102 transitions to singulated command start state 316 from tree traversal state 312 upon receipt of a data “NULL” after successful negotiation of all bits in identification bit string or in the portion of the identification bit string being read.

In traversal mute state 314, tag 102 receives data from reader 104. However, when in traversal mute state 314, tag 102 provides no responses to reader 104. Thus, traversal mute state 314 disables tag 162 from responding to a particular request or command from reader 104. Note that during tree traversal, global command, and singulated command operations, one or more tags 102 may be active (e.g., in tree traversal state 312, in global command state 308, or in singulated command state 316) or temporarily inactive (e.g., in traversal mute state 314). Any other tags that have been completely or partially processed will be in dormant state 302. Reader 104 may collectively address the full population of tags 120 through implicit instructions. This means that upon receipt of a certain symbol, tag 102 determines its action based upon its current state. Thus, tag 102 does not have to receive a complete “explicit” instruction to perform functions, resulting in less data needing to be transferred between reader 104 and tag 102.

For example, reader 104 may send a data “NULL” to the population of tags. Those tags that are in traversal mute state 314 transition to tree start state 310 and clear their null counter 240. Tags 102 in tree traversal state 312 transition to either traversal mute state 314 or singulated command start state 316 depending on the number of bits successfully negotiated when the data “NULL” was received, as described above.

When in tree start state 310, receipt of a data “0” causes tag 102 to transition to tree traversal state 312. Receipt of a data “NULL” causes tag 102 to increment the value of null counter 240. Tag 102 remains in tree start state 310 when a data “NULL” is received. Receipt of a data “1” causes tag 102 to transition to global command state 308.

In general, a tag 102 is placed in singulated command start state 316 following successful negotiation of all or a portion of its identification bit string. When in singulated command start state 316, if a data “1” is received from reader 104, tag 102 enters singulated command state 318. Receipt of a data “0” causes tag 102 to set its confirmed read flag 210 and transition to dormant state 302. In an embodiment, receipt of a data “NULL” does not effect the state of tag 102 in singulated command start state 314.

When operating in singulated command state 318, tag 102 receives a singulated command from reader 104. The singulated command consists of multiple bits. In an embodiment of the present invention, the command is 8 bits in length. Singulated command state 318 allows reader 104 to initiate features and functions on an individual tag, after the tag has been identified via a successful binary tree traversal. Tag 102 transitions from singulated command state to singulated command mute state 320 upon occurrence of event 358. In an embodiment, event 358 can be the detection of communications errors within a singulated command or a request for an unknown or disabled function. From singulated command mute state 320, tag 102 returns to singulated command start state 316 upon receipt of a data “NULL” from the reader.

Singulated command mute state 320 is similar in function to traversal mute state 314, described above. When operating in singulated command mute state 320, tag 102 receives data but does not respond to data transmitted by the reader.

1.3 Binary Tree Traversal Protocol

In accordance with an embodiment of the present invention, a binary tree traversal methodology is used in order to establish communication between a reader 104 and one of a population of tags 120 that are within the communication range of the reader. In an embodiment, contention between the tags 102 is avoided by requiring transmissions from each tag 102 to the reader 104 to be unique in a separation of frequency, but can be avoided in other ways. Contention may be defined as communications by multiple transmissions in the same frequency, time, and/or phase that thereby destructively interfere with each other's attempted transmission. Thus, in an example binary traversal algorithm, one bit of information is negotiated at a time between the reader 104 and the current population of tags 102 that the reader is addressing.

Each tag response is defined by two frequencies, one frequency for 0, and the other frequency for 1. In such a manner, many tags can simultaneously and non-destructively communicate a data 0. It is not important that the reader cannot differentiate a single data 0 from multiple data 0's, just that there exists a data 0. Alternatively, for example, a tag response may be defined by two time periods, one time period for “0”, and the other for “1.”

In an embodiment, the binary tree traversal process eliminates tags from communication until only one tag with a unique bit sequence is isolated and verified. As described above, each level in the binary tree represents a bit position in the tag identification bit sequence. As the reader proceeds through nodes (and levels) in the binary tree, it directs a subset of the population of tags to remain active and a subset of the population of tags to go inactive. For example, tags that last sent a matching bit remain active; those that did not will go inactive. Statistically, on each bit exchange, one half of the tag population will go inactive. This process continues until the reader reaches a node in the last level of the binary tree and results in a unique tag isolation and elimination. This process is repeated until each tag in the population of tags or each tag in a subset of the tag population is isolated.

Reader network 104 may employ the binary traversal protocol to interrogate a population of tags according to various techniques. A first example interrogation technique involves reading every tag 102 in a tag population 120 that can be detected. This technique is referred to as a general read interrogation. During a general read interrogation, reader network 104 traverses through the tag population by exchanging symbols with the tag population. During this process, when the reader network 104 receives two backscatter symbols simultaneously (such as a logical “0” and a logical “1”) in response to a transmitted signal, it selects one of these symbols to transmit next. In doing so, reader network 104 evokes responses from any tags 102 that match the transmitted symbol, and implicitly places the remaining, non-responsive undesired tags 102 into traversal mute state. This may continue until no more responses are evoked from tags 102, until a predetermined number of bits have been traversed, or until reader network 104 has otherwise determined it has finished traversing tags 102.

Another interrogation technique verifies that a particular bit sequence (e.g., a bit sequence that identifies a specific tag) exists within its communications range. This technique is referred to herein as a specific read interrogation. During a specific read interrogation, reader network 104 traverses through the tag population using a particular bit sequence.

For more information concerning binary tree traversal methodology, and, more generally, communication between an RFID reader and a population of RFID tags in accordance with an embodiment of the present invention, see U.S. Pat. No. 6,002,544, entitled “System and Method for Electronic Inventory” which is incorporated herein by reference in its entirety, and the following co-pending U.S. Patent Applications, each of which is incorporated by reference herein in its entirety: application Ser. No. 09/323,206, filed Jun. 1, 1999, entitled “System and Method for Electronic Inventory,” Attorney Docket No. 1689.0010001; application Ser. No. 10/072,885, filed Feb. 12, 2002, entitled “Method, System and Apparatus for Binary Traversal of a Tag Population,” Attorney Docket No. 1689.0210001; and application Ser. No. 10/073,000, filed Feb. 12, 2002, entitled “Method, System and Apparatus for Communicating with a RFID Tag Population,” Attorney Docket No. 1689.0260000.

2. Reader Directed Partial Binary Tree Traversal

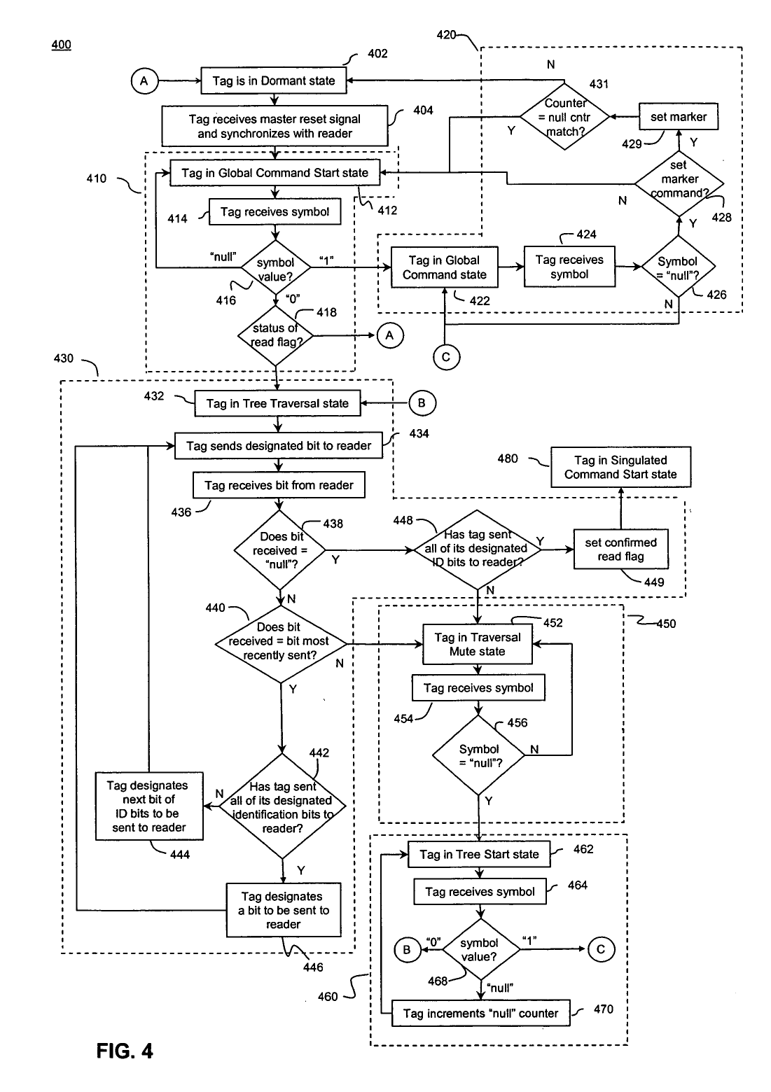

FIG. 4 is a flowchart 400 illustrating an example operation of reader directed partial binary tree traversal from the perspective of a single tag 102, according to an embodiment of the present invention. By operating according to flowchart 400, reader 104 can reduce the number of bits needed to read individual tags. Thus, the time required to read each tag can be significantly reduced. Flowchart 400 will be described with continued reference to the exemplary embodiments shown in FIGS. 1, 2 and 3 above. However, the invention is not limited to those embodiments. Note that some steps shown in flowchart 400 do not necessarily have to occur in the order shown.

As shown in FIG. 4, flowchart 400 begins with step 402. In step 402, tag 102 is in dormant state 302.

In step 404, tag 102 receives a master reset signal from reader 104. Upon receipt of the master reset signal, tag 102 transitions from dormant state 302 to calibration state 304. Tag 102 is also synchronized with reader 104 in this step. For example, in step 404, tag 102 performs oscillator calibration and data calibration with reader 104. Upon completion of synchronization, tag 102 transitions from calibration state 304 to global command start state 306.

In step 410, tag 102 performs operations while in global command start state 306. Step 410 includes steps 412-418.

In step 412, tag 102 enters or remains in global command start state 306.

In step 414, tag 102 receives a symbol from the reader.

In step 416, tag 102 determines the value of the symbol received. If a “NULL” is received, operation returns to step 412 (i.e., tag 102 remains in global command start state 306). If a data “1” is received, operation proceeds to step 420 (i.e., tag 102 transitions to global command state 308). If a data “0” is received, operation proceeds to step 418.

In step 418, tag 102 determines the status of the confirmed read flag 210. If confirmed read flag is set, operation returns to step 402 (i.e., tag 102 enters dormant state 302). If confirmed read flag is not set, operation proceeds to step 430 (i.e., tag 102 transitions to tree traversal state).

In step 420, tag 102 performs operations while in global command state 308. Step 420 includes steps 422-429.

In step 422, tag 102 enters or remains in global command state 308.

In step 424, tag 102 receives a symbol from reader 104.

In step 426, tag 102 determines whether a “NULL” was received. If a “NULL” was received, operation proceeds to step 428. A “NULL” signals the end of a received command. If “NULL” was not received (i.e., data “0” or data “1” received), operation returns to step 422 (i.e., tag 102 remains in global command state 308). Receipt of a data “0” or data “1” indicates that tag 102 is still receiving command data from reader 104.

In step 428, tag 102 determines whether a set marker command was received. If a set marker command was not received, operation returns to step 410 (i.e., tag 102 enters global command start state 306). If a set marker command was received, operation proceeds to step 429. Note that tag 102 may receive any global command during step 420. Although not illustrated, as would be appreciated by persons of skill in the art, the necessary steps to respond to the received command would be taken by tag 102 in step 420.

In step 429, tag 102 sets marker 230 to the appropriate bit position. In an embodiment, marker 230 indicates the first bit position for subsequent binary tree traversal. In cases where the marker is not placed at the first bit position of the full identification bit sequence, any subsequent binary tree traversal is a traversal of subset of the binary tree (i.e., a partial binary tree traversal). Operation then proceeds to step 431.

In step 431, tag 102 determines whether the value of null counter 240 matches null counter match variable 250. In an embodiment, tag 102 uses a comparator having the null counter match variable and the null counter as inputs. The output of the comparator is an indication of whether a match occurred. If a match occurs, operation proceeds to step 412. Tags that enter global command state in this manner are considered “selected” for partial tree traversal. If no match occurs, operation returns to step 402. Tags that enter dormant state in this manner are considered “unselected” for partial tree traversal.

In step 430, tag 102 performs operations while in tree traversal state 312. Step 430 includes steps 432-449.

In step 432, tag 102 enters or remains in tree traversal state 312.

In step 434, tag sends its designated bit to reader. When tag 102 initially transitions to tree traversal state 312, the designated bit is the first bit of the identification bit sequence. In an embodiment, the first bit of the identification bit sequence is the most significant bit (MSB). In an alternate embodiment, the first bit of the identification bit sequence is the least significant bit (LSB). Alternatively, if a set marker command was received prior to entry of tree traversal state 312, the designated bit is the bit in the bit position identified by marker 230.

In step 436, tag 102 receives a symbol from reader 104.

In step 438, tag 102 determines whether the symbol received was a “NULL.” If a “NULL” was received, operation proceeds to step 448. If a “NULL” was not received (e.g., data “0” or data “1” received), operation proceeds to step 440. Receipt of a data “0” or a data “1” causes tag 102 to proceed with binary tree traversal. Receipt of “NULL” causes tag 102 to transition to a different state.

In step 440, tag 102 determines whether the received symbol is equivalent to the bit most recently sent to reader 104. If the received symbol is equivalent to the most recently sent bit, operation proceeds to 442. This indicates a successful negotiation of the sent bit. If the received symbol is not equivalent to the most recently sent bit, operations proceeds to step 450 (i.e., tag 102 enters traversal mute state 314). This indicates an unsuccessful negotiation of the sent bit. Tag 102 is then considered an “unmatched” tag.

In step 442, the tag determines whether all bits of its identification bit sequence or all bits of the portion of its identification bit sequence being read have been sent to reader. If all bits have been sent, operation proceeds to step 446. If all bits have not been sent, operation proceeds to step 444.

In step 444, tag 102 designates the next bit of its identification bit sequence or next bit in the portion of its identification bit sequence being read for transmission to the reader. For example, if a marker was set at bit position A, the designated bit would be the bit in the position immediately next to bit position A. In this example, only a subset of bits (i.e., a portion) in the identification bit sequence is being read. Operation returns to step 434. Steps 434-444 are repeated until the entire identification bit sequence or portion of the bit sequence being read is successfully negotiated, until the tag unsuccessfully negotiates a bit and enters traversal mute state, or until the reader transmits a “NULL.”

In step 446, tag 102 has transmitted all identification bits to reader 104. To complete negotiation, tag 102 designates a bit to be sent to reader 102. In an embodiment, the designated bit is the same bit sent to reader 104 (e.g., the last bit in the identification bit sequence). In an alternate embodiment, the designated bit is a random bit. Step 446 indicates the successful negotiation of all bits in the identification bit sequence or portion of the identification bit sequence. Operation then returns to step 434.

In step 448, tag 102 determines whether the “NULL” symbol was received after the tag has transmitted all bits in the identification bit sequence or portion of the identification bit sequence being read to reader 104. If all bits have been transmitted, operation proceeds to step 449. If all bits have not been transmitted, operation proceeds to step 450 (i.e., tag enters traversal mute state 314). Tags 102 entering traversal mute state 314 in this manner are considered “matched tags.”

In step 449, the confirmed read flag 210 is set and operation proceeds to step 480 (i.e., tag 102 enters singulated command start state 316).

In step 450, tag 102 performs operations while in traversal mute state 314. Step 450 includes steps 452-456.

In step 452, tag 102 enters or remains in traversal mute state 314.

In step 454, tag 102 receives a symbol from reader 104.

In step 456, tag 102 determines whether a “NULL” was received. If “NULL” was received, operation proceeds to step 460. If “NULL” was not received, operation returns to step 452.

In step 460, tag 102 performs operations while in tree start state 310. Step 460 includes steps 462-472.

In step 462, tag 102 enters or remains in tree start state 310.

In step 464, tag 102 receives a symbol from reader 104.

In step 468, tag 102 determines the value of the received symbol. If a “NULL” was received, operation proceeds to step 470. If a data “1” was received, operation proceeds to step 422. Receipt of a data “1” causes tag 102 to transition to global command state. If a data “0” was received, tag 102 transitions to tree start state 310 and operation returns to step 432.

In step 470, tag 102 increments the value of null counter 240 and operation returns to step 462. In an alternate embodiment, tag 102 decrements its null counter.

In step 480, tag 102 performs operations while in singulated command start state. While in singulated command start state 316, tag 102 transitions to dormant state upon receipt of a data “0” or to singulated command state upon receipt of a data “1.” If a data “0” is received, tag 102 sets its confirmed read flag to indicate tag 102 was read.

At this point, tag 102 has successfully negotiated its full tag identification sequence or a partial identification sequence.

The process of FIG. 4 provides a mechanism for reducing the number of bits required to successfully negotiate identification information from a group of tags in a tag population. By reducing the number of bits, the read time for each tag in the group can be reduced. Thus, a significant increase in the read rate for the tag population can be achieved through the process of FIG. 4.

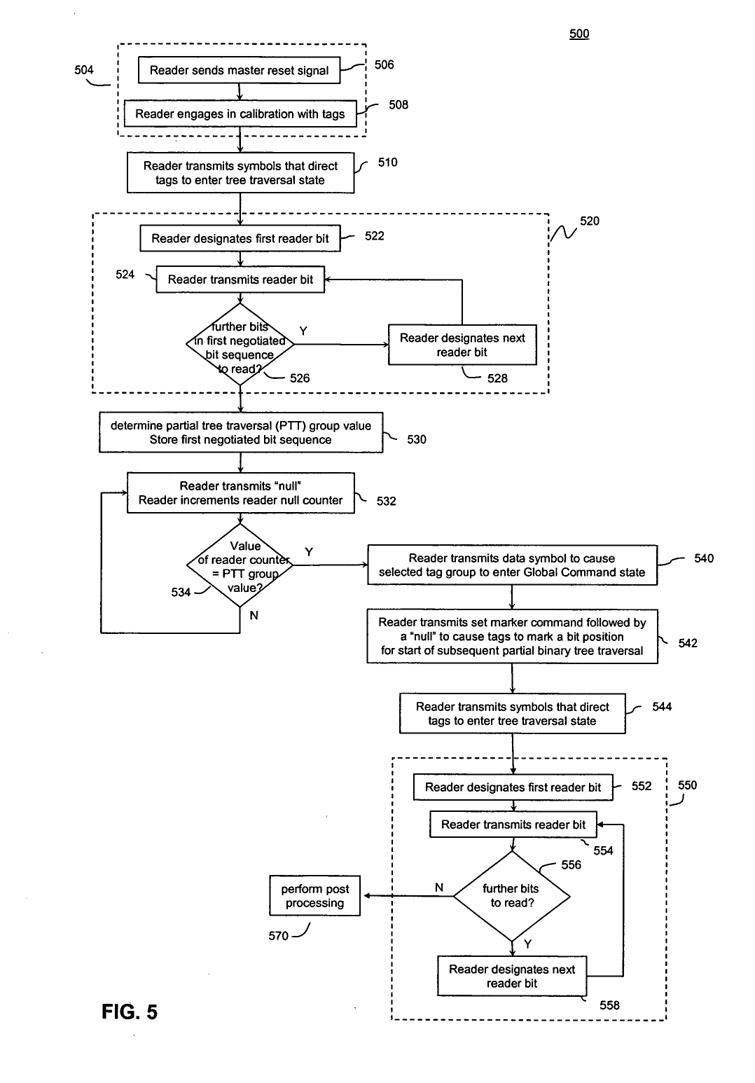

FIG. 5 is a flowchart 500 illustrating an example operation of the reader directed partial binary tree traversal from the perspective of reader 104, according to an embodiment of the present invention. Flowchart 500 will be described with continued reference to the exemplary embodiments shown in FIGS. 1, 2 and 3 above. However, the invention is not limited to those embodiments. Note that some steps shown in flowchart 500 do not necessarily have to occur in the order shown.

In step 504, the reader engages in start-up processing. Start-up signals are sent at the beginning of the interrogation of a population of tags 120. During the process, the reader emits signals to power the tags and to configure detailed timing points as required by the protocol. FIG. 5 depicts start-up processing as including two steps: 506 and 508.

In step 506, reader 104 sends a master reset signal. The master reset signal causes tags 102 within the communication range of reader 104 to transition to calibration state 304.

In step 508, reader 104 engages in calibration with tags 102. For example, reader 104 and tags 102 undergo oscillator and data calibration operations. Upon successful completion of calibration, tags 102 transition to global start state. As will be appreciated by persons skilled in the relevant arts, other methods for start-up processing 504 can be used without departing from the spirit or scope of the present invention.

In step 510, reader 104 sends one or more symbols causing active tags 102 to enter tree traversal state 312.

In step 520, reader 104 reads a first negotiated bit sequence according to a binary tree traversal protocol. In an embodiment, step 520 includes steps 522-528, described below. As would be appreciated by persons of skill in the art, other techniques for negotiating the first negotiated bit sequence could be used with the present invention.

In an embodiment, the number of bits in the first negotiated bit sequence equals the number of bits in a complete tag identification number. This is referred to herein as a “full identification sequence interrogation.” In an alternate embodiment, the number of bits in the first negotiated bit sequence is less than the number of bits in a complete tag identification number. This is referred to herein as a “partial identification sequence interrogation.” In this embodiment, the reader is performing one or more partial tree traversals on the tag population 120.

In an embodiment, the number of bits in the first negotiated bit sequence is predetermined. For example, the reader determines that binary tree traversal should be performed to negotiate a specific number of bits (e.g., 32 bits). In this embodiment, the reader may use a predefined sequence to direct the binary tree traversal. For example, a predefined sequence (e.g., 101000) could be used by the reader as the first negotiated bit sequence. In this embodiment, reader 104 issues signals during binary tree traversal that step tags through the predefined sequence regardless of the signals transmitted from tags to reader 104. Alternatively, the reader may perform a general read binary tree traversal, as described above. In this embodiment, binary tree traversal is performed until the reader receives both a “0” and a “1” from the tag population at a bit position. Thus, the values in the bit positions negotiated prior to the receipt of both a “0” and a “1” are identical for the tags in the tag population 120. The reader then only needs to negotiate the subsequent bit positions.

In step 522, reader 104 designates a first reader bit.

In step 524, reader 104 transmits the reader bit to tags 102.

In step 526, a determination is made whether any further bits in first negotiated bit sequence remain to be read. If bits remain to be read, operation proceeds to step 528. If no bits remain to be read, operation proceeds to step 530.

In step 528, reader 104 designates the next reader bit and operation returns to step 524.

In step 530, reader 104 determines the value of partial tree traversal group variable 260 if a complete tag identification is not negotiated in step 520. In this embodiment, the value of partial tree traversal group variable 260 indicates the number of “NULL” signals that reader 104 transmits to cause a “matched” tags to perform partial binary tree traversal. In an embodiment, reader 104 optionally stores the value of the bits in the first bit sequence.

In step 532, reader 104 transmits a “NULL” symbol to tags 102 and increments reader null counter 270. The first “NULL” symbol transmitted causes tags 102 in tree traversal state 312 (“matched tags”) to transition to traversal mute state 314 and tags 102 in traversal mute state 314 (“unmatched tags”) to transition to tree start state 310 and clear their tag null counter. The second “NULL” symbol transmitted causes tags 102 in traversal mute state 314 (“matched tags”) to transition to tree start state 310 and clear their tag null counter and tags in tree start state 310 (“unmatched tags”) to increment their tag null counter. Any subsequent “NULL” symbol transmitted causes “matched tags” and “unmatched tags” to increment their tag null counter. Thus, “unmatched tags” will always have higher tag null counter value than “matched tags.”

In step 534, reader 104 determines whether the value of the partial tree traversal group variable equals the value of reader null counter. If the value of partial tree traversal group variable equals reader null counter, operation proceeds to step 540. This indicates that reader 104 is ready to the tags to enter global command state. If the value of partial tree traversal group variable does not equal reader null counter, operation returns to step 532.

Steps 532 and 534 are repeated until the value of null counter match variable equals the value of reader null counter. As would be appreciated by a person of skill in the art, other methods could be used to determine when the reader should transmit a data symbol to cause selected tag groups to enter Global Command state. For example, the reader could set a counter or variable equal to the null counter match variable and decrement the counter/variable until zero is reached.

In step 540, reader 104 transmits one or more symbols which cause tags 102 to transition to global command state 308.

In step 542, reader 104 transmits a set marker command followed by a “NULL” symbol to cause tags 102 in global command state 308 (i.e., “selected tags”) to mark a bit position for the start of a subsequent partial binary tree traversal and to direct those tags to transition to global command start state. In addition, this step causes tags to evaluate the value of their null counters. Tags 102 having the value of their null counter 240 equal to the tag null counter match variable 250 transition to global command state 308. These tags have been selected for subsequent partial tree traversal (i.e., “selected tags”). Tags 102 having the value of their null counter 240 not equal to the tag null counter match variable 250 transition to dormant state. These tags have not been selected for subsequent partial tree traversal (i.e., “unselected tags”).

In step 544, reader 104 sends one or more symbols causing the selected tags 102 to enter tree traversal state 312.

In step 550, reader 104 reads the subsequent negotiated bit sequence according to a binary tree traversal protocol. In an embodiment, step 550 includes steps 552-558, described below. As would be appreciated by persons of skill in the art, other techniques for negotiating the subsequent negotiated bit sequence could be used with the present invention.

In an embodiment, the number of bits in the subsequent negotiated bit sequence equals the number of bits remaining to be read in a tag identification number. In an alternate embodiment, the number of bits in the subsequent negotiated bit sequence is less than the number of bits remaining to be read in a tag identification number.

In step 552, reader 104 designates a first reader bit.

In step 554, reader 104 transmits the reader bit to tags 102.

In step 556, a determination is made whether any further bits in the subsequent negotiated bit sequence remain to be read. If bits remain to be read, operation proceeds to step 558. If no bits remain to be read, operation proceeds to step 560.

In step 558, reader 104 designates the next reader bit and operation returns to step 554.

In step 570, reader 104 performs post processing. This step is optional. For example, if reader 104 is performing partial tree traversal on “matched tags,” reader 104 may append the first negotiated bit sequence to the subsequent negotiated bit sequence.

3. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a radio frequency identification (RFID) reader for interrogating an RFID tag population, comprising the steps of:
(a) reading a first portion of a tag identification bit sequence of tags in the population of tags using a tag interrogation protocol;
(b) causing the tags in the tag population to transition to a state for receiving reader commands;
(c) transmitting a command to cause a first group of tags in the tag population to each set a marker at a specific bit position of their respective tag identification bit sequence and to transition to a state for negotiating a second portion of the tag identification bit sequence; and
(d) reading the second portion of the tag identification bit sequence for a first tag in the first group of tags starting from the marked specific bit position using the tag interrogation protocol.

2. The method of claim 1, further comprising the step of:
(e) repeating step (d) for each remaining tag in the first group of tags.

3. The method of claim 1, wherein step (a) comprises:
determining bit values in the first portion of the tag identification bit sequence; and
reading the first portion of the tag identification sequence according to a specific read binary tree traversal protocol, wherein the reader uses the determined values for the bits in the first portion of the tag identification bit sequence to direct the specific read.

4. The method of claim 1, wherein step (a) comprises:
reading the first portion of the tag identification sequence according to a general read binary tree traversal protocol; and
ending the read of the first portion of the tag identification sequence when the reader receives both a data “0” and a data “1” from the tags in the tag population for a current bit position being read,
wherein bit values in bit positions negotiated prior to the current bit position being read comprise the first portion of the tag identification sequence.

5. The method of claim 1, wherein step (b) further comprises:
causing a second group of tags in the tag population to transition to a dormant state.

6. The method of claim 1, wherein step (c) further comprises:
transmitting a bit position indicator following the command.

7. The method of claim 1, wherein the first group of tags have tag identification sequences matching the first portion of the tag identification sequence for all read bit positions.

8. The method of claim 1, wherein the tag interrogation protocol is a binary tree traversal protocol.

9. The method of claim 2, further including the steps of:
appending the first portion of the tag identification sequence to each second portion of the tag identification sequence read.

10. A method in a radio frequency identification (RFID) tag for communicating with a reader, comprising the steps of:
(a) engaging in negotiation of a first portion of an identification sequence associated with the tag according to an interrogation protocol;
(b) transitioning to a state for receiving commands from the reader upon receipt of a first sequence of symbols;
(c) receiving a set marker command;
(d) setting a bit position for start of negotiation of a second portion of the identification sequence associated with the tag; and
(e) engaging in negotiation of the second portion of the identification sequence associated with the tag according to the interrogation protocol, wherein the negotiation of the second portion begins at the set bit position.

11. The method of claim 10, wherein step (b) comprises the steps of:
(i) transitioning to a negotiation start state upon receipt of a second sequence of symbols;
(ii) tracking each time a symbol having a first value is received while the tag is in the negotiation start state; and
(iii) transitioning to the state for receiving commands when a symbol having a second value is received.

12. The method of claim 11, wherein step (d) further comprises transitioning to a negotiation state when the symbol having a first value was received a predetermined number of times while the tag was in the negotiation start state.

13. The method of claim 10, wherein step (d) comprises setting the bit position for start of the negotiation of the second portion of the identification sequence at the bit position immediately next to the last bit position negotiated during negotiation of the first portion of the identification sequence.

14. The method of claim 10, wherein step (c) further comprises:
receiving a bit position indicator following the set marker command.

15. The method of claim 14, wherein step (d) comprises setting the bit position for start of the negotiation of the second portion of the identification sequence at the bit position received in the bit position indicator.

16. The method of claim 11, wherein the interrogation protocol is a binary tree traversal protocol.

17. The method of claim 12, wherein step (b)(ii) includes:
incrementing a counter each time the symbol having the first value is received when the tag is in the negotiation start state.

18. The method of claim 12, wherein step (d) includes:
upon receipt of the set marker command, comparing the value of the counter to a value of a stored variable; and
transitioning to a command start state when the value of the counter equals the value of the stored variable.

19. The method of claim 11, wherein step (b)(ii) includes:
setting the value of a counter to a predetermined number;
decrementing the counter each time the symbol having the first value is received when the tag is in the negotiation start state.

20. The method of claim 19, wherein step (d) includes:
upon receipt of the set marker command, examining the value of the counter; and
transition to a command start state when the value of the counter equals zero.
